(19) United States
(12) Patent Application Publication
(10) Pub. No.: US 2018/0150777 A1
(43) Pub. Date: May 31, 2018

(54) GLOBAL CONSTRUCTION BUSINESS MANAGEMENT APPARATUS, MANAGEMENT METHOD USING THE SAME, AND GLOBAL CONSTRUCTION BUSINESS MANAGEMENT SYSTEM

(71) Applicant: PM-Pgm Co., Ltd., Seoul (KR)

(72) Inventors: Sang-Won HAN, Seoul (KR); Yong-Woon CHA, Seoul (KR); Zheng Xun JIN, Seoul (KR); Jin-Ho JUNG, Seoul (KR); Chang-Taek HYUN, Seoul (KR); Su-Sang LIM, Seoul (KR); You-Sang YOON, Seoul (KR); Hyun-Jong LEE, Gwangmyeong-si (KR)

(21) Appl. No.: 15/489,867

(22) Filed: Apr. 18, 2017

(30) Foreign Application Priority Data
Nov. 29, 2016 (KR) 10-2016-0160542

(51) Int. Cl. G06Q 10/06; G06Q 50/08

(52) U.S. Cl. CPC G06Q 10/0633; G06Q 50/08

(57) ABSTRACT

A global construction business management apparatus and a global construction business management system using the same. The global construction business management apparatus includes: an electric manual unit: deriving a task hierarchy in life stages to include a ‘plan and program stage’, a ‘design stage’, a ‘construction order and contract stage’, a ‘construction stage’, and an ‘operation and maintenance stage’ based on business process breakdown structure (BPS) information; providing to a responsible entity information required for performing a task; and providing performed task information to any one of the responsible entity, a revising entity, or an assigning entity; and a BPS mapping unit providing visualized information so that a temporal flow of the task hierarchy in life can be easily comprehended. Accordingly, an i-PgMIS is applied to a global construction project and used for various businesses by improving the i-PgMIS that is limited to an urban regeneration business.

### CROSS REFERENCE TO RELATED APPLICATION

The present application claims priority to Korean Patent Application No. 10-2016-0160542, filed Nov. 29, 2016, the entire content of which is incorporated herein for all purposes by this reference.

### BACKGROUND OF THE INVENTION

### 1. Field of the Invention

The present invention generally relates to a global construction business management apparatus including an electric manual unit based on a BPS by delivery method and a system for managing a global construction business using the electric manual unit. More particularly, the present invention relates to a global construction business management apparatus and a global construction business management system using the same, the apparatus including an electric manual unit based on a BPS by delivery method, and the electric manual unit being capable of systematically performing tasks of design, construction, and maintenance stages according to delivery methods by implementing a global BPS that may be applied to general large-scale construction projects and by making the global BPS to an electric manual into be efficiently used for helping actual construction business workers.

### 2. Description of Related Art

Due to limited space in the urban areas, there is a need for developing three-dimensional complex spaces having various functions such as residential, commercial, public, etc., and such developments take place not only in horizontal space but also in vertical space. Accordingly, when more two projects progress at the same time, the comprehensive urban regeneration comprehensive businesses (a concept wherein a plurality of projects or unit facilities are combined with each other and take on a status higher than that of a single project) take on characteristics of a program. In order to reduce financial risk associated with large-scale projects, a special purpose company (SPC) that is established by a public or private cooperation, or a third parity system business is established. However, this also creates another risk factor, such as an occurrence of disputes due to the participation of various entities. There are increasing cases in which different participants have conflicts and thus business promotion becomes difficult.

In other words, recently, construction businesses are promoted as a program rather than according to, as in a conventional unit project, a variety of participants, a large business expense, and a long term business period. Due to a diversity of participant entities, large-scale business expenses incurring over a long time, various laws and regulations, lack of experience of performing a business, etc., businesses may not proceed smoothly.

Thus, there is a need for a global business management system based on a life cycle, wherein the system is capable of examining and managing a number of businesses in combination.

Under such circumstances, an urban regeneration global business management system (intelligent Program Management Information System, hereinafter, ‘i-PgMIS’) has been developed and registered as Korean Patent No. 10-1330519 (Nov. 12, 2013). The i-PgMIS discloses a technique in which an urban regeneration business is designed in whole stages, an ordering organization that performs the business is aware of changes in business expenses and a business schedule associated with changes in a business plan, and the business expenses and the business schedule are predicted and managed. In addition, the i-PgMIS discloses techniques of planning, programming, and examining feasibility, preparing constructing, operating, and maintaining a business in life stages, rather than a conventional unit project, the business being a program of a multi-dimensional complex level by vertically integrating functions that are horizontally distributed and by three-dimensionally reconfiguring the integrated functions.

Such large-scale construction businesses have been promoted in various types according to business entities, delivery methods, etc., various types of task promotion methods are being created, and demand for task support systems of a suitable type is also increasing.

In other words, since the current i-PgMIS is developed only in a form specific for urban regeneration projects, the i-PgMIS should be complemented with a form capable of supporting general large-scale projects so that the i-PgMIS can be globally applied. Accordingly, there is a need for newly establishing a business process breakdown structure (BPS) and implementing a task supporting system.

Meanwhile, in Korea, various delivery methods such as ‘design-bid-build system’, ‘design-build system’, ‘alternate bid system’, ‘schematic design technical proposal bid system’, and ‘design technical proposal bid system’ are used in large-scale construction projects. Particularly, according to ‘Deliberation criteria for bidding method for large-scale construction’ of Ministry of Land, Infrastructure and Transport, the delivery method is stipulated to be decided after being considered by the Central Construction Deliberation Committee.

Thus, the ordering organization determines the delivery method of the corresponding business before deliberation is requested, and the ordering organization has difficulty in selecting the delivery method since there are many important factors that determine success or failure of business and there are many factors to consider when determining the ordering method.

Accordingly, systems for selecting the most profitable bidding method or related research have been conducted by categorizing studies for methods of determining delivery method selection standard, or bidding method selections into ‘Competition’ and ‘Risk’ based on case-based reasoning (CBR).

However, conventional studies are mainly focused on selecting an ordering organization and bidding contract methods, and are insufficient for considering whether or not the business is smoothly progressing, whether or not the business is being operated without problems after completion, etc.

In addition, construction value engineering (VE) has emerged in order to advance underdeveloped technologies in the construction field and to ensure secure economic efficiency by removing inefficiency. Value engineering (VE) refers to organized tasks in which various experts of different fields cooperate to ensure necessary functions by using the minimum life cycle cost (LCC) while basic features such as functions, qualities, etc. of construction buildings are maintained and maximized.

In detail, the principle of construction value engineering includes a method of reducing costs or improving functions, a method of achieving innovative improvements, a method of enforcing functions even though the cost rises, etc. Regulations and standards that should be satisfied for the development of technology and the convenience of mankind are increasing. On the other hand, due to changes of construction environments where the cost of human resources and material resources is rising, and the absolute quantity of the material resources is running out, the above-mentioned construction value engineering (VE) has been increasingly demanded in the construction field, and an effect thereof is father being recognized.

In addition, since the construction field is faced with fundamental problems such as resource depletion and environmental destruction, a scheme is being sought that is capable of creating a comfortable indoor environment without creating an adverse effect on the external natural environment or on human beings without using energies and in harmony with the external environment, as a building itself.

Accordingly, global attempts to evaluate the eco-friendly value of buildings are in progress, and, in Korea, systems such as an eco-friendly building certification system, a building energy efficiency level certification system, an energy saving design standard system for buildings, and a renewable energy mandatory system of public institutions, etc. has been introduced. However, in conventional VE engineering, the eco-friendly values of the above described buildings are not considered, and even when considered, the values have dealt mostly in terms of energy consumption for efficient use of energy.

In addition, construction projects are subdivided into a plan design stage, a program design stage, a basic design stage, an implementation design stage, a construction stage, and a maintenance stage, but conventional construction value engineering (VE) does not consider features of respective stages of a life cycle of a project as described above, effectiveness is low, and accuracy is reduced since there is no way to share data between stages although each project example is datafied.

In addition, recently, since construction businesses have become larger, the number of program-level projects that integrate multiple projects has increased. However, conventional construction value engineering (VE) is only performed on each project unit, and it is not possible to integrate and manage a number of projects. In addition, there is a limit in setting common goals or sharing information for the number of projects that is related to a single program.

The foregoing is intended merely to aid in the understanding of the background of the present invention, and is not intended to mean that the present invention falls within the purview of the related art that is already known to those skilled in the art.

### DOCUMENTS OF RELATED ART

(Patent Document 1) Korean Patent No. 10-1330519.

### SUMMARY OF THE INVENTION

Accordingly, the present invention has been made keeping in mind the above problems occurring in the related art, and the present invention is intended to complement a conventional i-PgMIS that is limited to urban regeneration businesses so that the i-PgMIS may be applied to a BPS and detailed modules thereof be applied to a global construction business, whereby the i-PgMIS can be used for various businesses. In addition, the present invention aims to develop BPSs of respective delivery methods, rather than a BPS of a single delivery method, based on current construction related regulations, to show the same information according to time flow, to provide related legal information, and to manage the relevant laws and regulations to be revised.

In addition, another object of the present invention is to provide a global construction business management apparatus and global construction business management system using the same, the apparatus including an electric manual unit based on a BPS by delivery method which provides objective standards for selecting a delivery method and also considers a result of a delivery method of a related established business after the delivery method has been selected.

In addition, still another object of the present invention is to provide a construction value engineering (VE) integrated management system for eco-friendly construction, while performing a construction project, that provides a construction VE considering an eco-friendly value of a building; sets a direction of a project by using a network of experts belonging to a construction inspection company, an ordering organization, a designer firm, and a construction company, shares ideas with each other, stores each stage information of the project; provides each stage information to the following stages or to another project; sets common goals for a number of projects that is related to a program; and shares information therebetween.

In order to achieve the above object, according to one aspect of the present invention, there is provided an apparatus for managing a global construction business, the apparatus including an electric manual unit: deriving a task hierarchy in life stages to include a ‘plan and program stage’, a ‘design stage’, a ‘construction order and contract stage’, a ‘construction stage’, and an ‘operation and maintenance stage’ based on business process breakdown structure (BPS) information stored in a database according to delivery method selection information input by an ordering organization; providing to a responsible entity information required for performing a task and providing to any one of the responsible entity, a revising entity, or an assigning entity performed task information performed by the responsible entity, and a BPS mapping unit providing visualized information so that a temporal flow of the task hierarchy in life stages derived by the electric manual unit can be easily comprehended.

In addition, the electric manual unit may include: a BPS deriving unit constituting the task hierarchy in life stages of a first level to a third level based on the BPS information stored in the database according to the delivery method selection information input by the ordering organization; an input unit providing information required for performing a task that is required for performing a third level task, and receiving and storing the performed task information performed by the responsible entity, an output unit providing the performed task information performed by the responsible entity to any one of the responsible entity, the revising entity, or the assigning entity, and a legal history providing unit providing legal information related to performing a third level task.

In addition, the apparatus may further include a delivery method selecting unit selecting any one of a ‘design-bid-build system’, a ‘design-build system’, an ‘alternate bid system’, a ‘schematic design technical proposal bid system’, or a ‘working design technical proposal bid system’ as a delivery method based on construction project post-evaluation information stored in the database according the delivery method selection information input by the ordering organization.

In addition, the delivery method selecting unit may include: a parameter value deriving unit deriving parameter values of parameter factors of a corresponding business based on the delivery method selection information including order information and construction business information; a weighted value calculating unit deriving degrees of influence of the respective parameter factors on selecting the delivery method as weighted values based on the construction project post-evaluation information stored in the database; and a delivery method deriving unit deriving a delivery method of an established business having the highest similarity based on the parameter values of the parameter factors of the corresponding business and derived weighted values of the parameter factors.

In addition, the delivery method selecting unit may includes a performance factor deriving unit deriving a result value of a performance factor including at least one of a rate of change in a business expense relative to a planned expense, a rate of change in business period relative to a planned period, and a benefit cost (B/C) ratio of each established business based on the construction project post-evaluation information stored in the database.

In addition, the delivery method selecting unit may include: a performance calculating unit calculating a performance of the established business as an index based on the derived result value of the performance factor and influence values of the respective performance factors.

Meanwhile, there is provided a method of managing a global construction business, the method being performed by an electric manual unit and including: a BPS deriving step S100 of deriving a task hierarchy by a life cycle to include a ‘plan and program stage’, a ‘design stage’, a ‘construction order and contract stage’, a ‘construction stage’, and an ‘operation and maintenance stage’ based on BPS information stored in a database according to delivery method selection information input by an ordering organization; a necessary information providing step S200 of providing to a responsible entity information required for performing a task; and a performed task information providing step S300 of providing performed task information performed by the responsible entity to any one of the responsible entity, a revising entity, or an assigning entity.

In addition, the method may further include: a visual information providing step S400 of proving visualized information so that a temporal flow of the task hierarchy in life stages derived by the electric manual unit can be easily comprehended, the method being performed by a BPS mapping unit.

In addition, in the necessary information providing step S200, the electrical manual unit may provide legal information related to performing a task.

In addition, the method may further include: a delivery method selecting step S000 of selecting any one of a ‘design-bid-build system’, a ‘design-build system’, an ‘alternate bid system’, a ‘schematic design technical proposal bid system’, or a ‘working design technical proposal bid system’ as a delivery method based on construction project post-evaluation information stored in the database according to the delivery method selection information input by the ordering organization, the method being performed by the delivery method selecting unit and before the BPS deriving step S100.

In addition, the delivery method selecting step S000 may include: a parameter value deriving step S010 of deriving parameter values of parameter factors of a corresponding business based on the delivery method selection information including order information and construction business information; a weighted value calculating step S020 of calculating degrees of influence of the respective parameter factors on selecting the delivery method as weighed values based on the construction project post-evaluation information stored in the database; and a delivery method deriving step S030 of deriving a delivery method of an established business having the highest similarity based on the parameter values of the parameter factors of the corresponding business and derived weighted values of the parameter factors.

In addition, the delivery method selecting step S000 may include: a performance factor deriving step S040 of deriving a result value of a performance factor including at least one of a rate of change in business expenses relative to planned expenses, a rate of change in business period relative to a planned period, and a B/C ratio of each established business based on the construction project post-evaluation information stored in the database.

In addition, the delivery method selecting step S000 may include: a performance calculating step S050 of calculating a performance of the established business as an index based on the derived result value of the performance factor and influence values of the respective performance factors.

Meanwhile, there is provided a system for managing a global construction project, wherein the system includes: a database storing business management information for a construction business; a global construction business management apparatus receiving/transmitting the business management information from/to the database; and a terminal for inputting the business management information to the global construction business managing apparatus and for receiving performed business management information, the global construction business managing apparatus includes: an electric manual unit: deriving a task hierarchy in life stages to include a ‘plan and program stage’, a ‘design stage’, a ‘construction order and contract stage’, a ‘construction stage’, and an ‘operation and maintenance stage’ based on a business process breakdown structure (BPS) information stored in a database according to delivery method selection information input by an ordering organization; providing to a responsible entity information required for performing a task, and providing performed task information performed by the responsible entity to any one of the responsible entity, a revising entity, or an assigning entity and a BPS mapping unit providing visualized information so that a temporal flow of the task hierarchy in life stages derived by the electric manual unit can be easily comprehended.

According to a global construction business management apparatus including an electric manual based on a BPS by delivery method and a global construction business management system using the same of the present invention, an i-PgMIS that is limited to urban regeneration projects may be improved to be applied to a global construction project, thus the i-PgMIS may be used for various businesses.

In addition, a characterized BPS by delivery method, rather than a single delivery method, may be derived by using delivery method selection information input by an ordering organization and based on current construction related regulations.

In addition, the BPS may be shown by stage according to time flow by using a BPS mapping unit.

In addition, a delivery method selecting unit may provide a delivery method based on the delivery method selection information input by the ordering organization based on an objective standard for selection the delivery method.

In addition, a performance factor deriving unit of the delivery method selecting unit functions to provide the delivery method and further to consider a result of a delivery method of a related established business.

In addition, since a life cycle assessment (LCA) of a project is analyzed by using a project analyzing unit of an eco-friendly value engineering/life cycle cost analyzing unit, an eco-friendly value of a building such as CO₂ emission quantity may be considered.

In addition, a project data unit may include a plan stage data unit, a program stage data unit, a basic stage data unit, an implementation stage data unit, a construction stage data unit, and a maintenance stage data unit so that VE project information is stored by project stage. A project analyzing unit may receive function input of the project by stage, a project executing unit may provide the VE project information stored in each project data unit or provide the VE project information to another project.

In addition, a project integrated managing unit may select a plurality of projects, but the plurality of projects that is integrally managed and performed may share VE project information with a project integrated management example data unit to set common goals or share information between the plurality of projects that is related to a program.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a view schematically showing a configuration of a global business management system according to the present invention;

FIG. 2 is a block diagram schematically showing an internal configuration of a construction business management apparatus of the present invention;

FIG. 3 a block diagram schematically showing an internal configuration of a web control room server of the present invention;

FIG. 4 is a block diagram schematically showing an internal configuration of a business participant entity system server of the present invention;

FIG. 5 is a block diagram schematically showing an internal configuration of an electric manual/conflict managing module of the present invention;

FIG. 6 is a conceptual diagram showing a delivery method defined in the present invention;

FIG. 7 shows visualized information provided by a BPS mapping unit according to an embodiment of the present invention;

FIG. 8 is a block diagram showing a global business management method performed by the electric manual/conflict managing module of the present invention;

FIG. 9 is a conceptual diagram showing a VE database of the present invention;

FIG. 10 is a block diagram schematically showing an internal configuration of an eco-friendly value engineering/life cycle cost analysis module of the present invention;

FIG. 11 is a conceptual diagram showing a project data unit of the present invention;

FIG. 12 is a conceptual diagram showing the system including a project integrated managing unit of the present invention; and

FIG. 13 is a block diagram schematically showing an internal configuration of an analysis deriving unit of the present invention.

### DETAILED DESCRIPTION OF THE INVENTION

Hereinbelow, exemplary embodiments of the present invention will be described in detail with reference to the accompanying drawings.

Meanwhile, in the specification, the described unit means ‘a block configured so as to change a hardware or software system or to be pluggable’, in other words, it means a unit or block that performs a specific function in hardware or software.

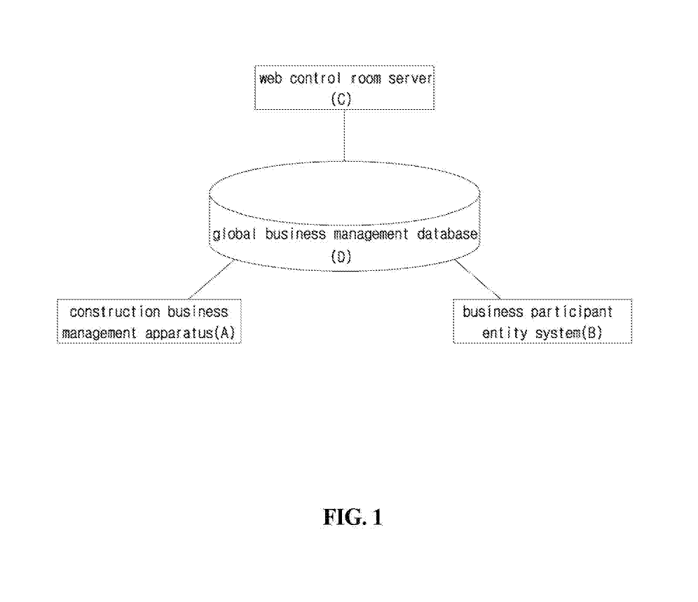

FIG. 1 is a view schematically showing a configuration of a global business management system according to the present invention.

A global business management system according to the present invention may include: a construction business management apparatus A, a global business management database D, a business participant entity system B, and a web control room server C.

The construction business management apparatus A receives business management information stored in the global business management database D according to a global business progress while progressing a global business, receives from a user parameter input that is necessary for analyzing business management information, and analyzes the business management information, and transmits the analyzed information to the global business management database D.

The global business management database D is configured to receive and store the business management information from the construction business management apparatus A, and transmit the business management information when the construction business management apparatus A, the business participant entity system B, or the web control room server C requires the business management information.

The business participant entity system B is configured to receive business management information of a plurality of unit facilities from the global business management database D, analyze the business management information, and provide the information to the business participant entities that participate the global business.

The web control room server C is configured to receive business management information of a plurality of business participant entities from the global business management database D, and provide the business management information to a business manager.

The present invention separately manages a project of a unit facility and at the same time, manages a business in a program dimension formed by combining a plurality of projects.

In the present invention, in a program where there is a need to build a number of unit facilities by specific area units, such as a urban regeneration global business, each business operator that builds a unit facility inputs, analyzes, and stores information related to a business by using the construction business management apparatus A. Meanwhile, a local government that conducts and controls the urban regeneration global business obtains, manages, and inspects information of each unit facility through a business participant entity system. Meanwhile, a national organization that manages and supervises each local government and progresses program at the national level (for example, Ministry of Land, Transport and Maritime Affairs) manages each business operator that is an entity that performs a project of building each unit facility by participating in a corresponding global business conducted by each local government, and determines a direction of a program progress through the web control room server C.

In the present invention, the global business may be progressed, analyzed, monitored, and predicted through a system in which various entities related to the global business are integrated. The system may be adjusted according to roles of respective entities, thus large-scale national programs may be managed more systematically and efficiently than a conventional technique in which a construction management of each unit facility was available. Accordingly, resources, time, and expenses required for the global business may be reduced, and a business progress of each unit facility may be effectively managed by predicting a future progressing direction of the global business.

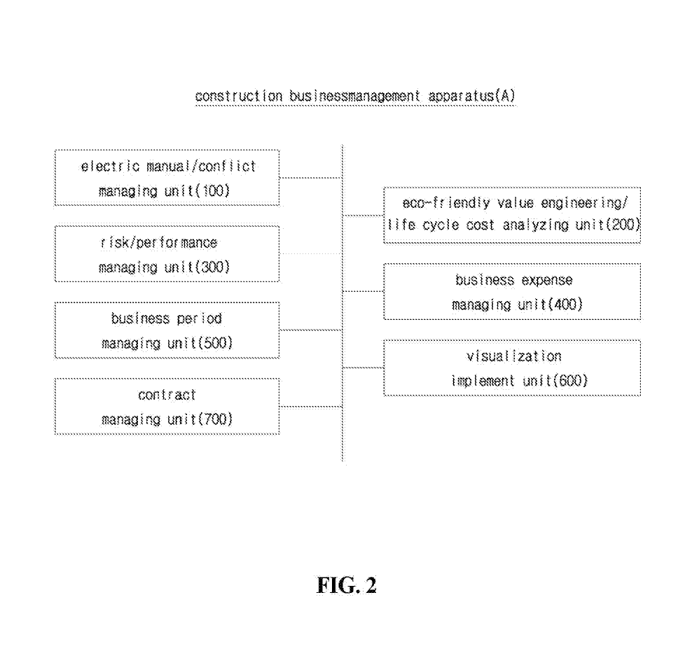

FIG. 2 is a view schematically showing an internal configuration of the construction business management apparatus A according to the present invention. The construction business management apparatus A of the present invention may include: an electric manual/conflict managing module 100, an eco-friendly value engineering/life cycle cost analyzing module 200, a risk/performance managing module 300, an business expense managing module 400, a business period managing module 500, a visualization implementing module 600, and a contract managing module 700.

First, the business expense managing module 400 is configured to receive business expense execution information by period of a unit facility from a user, receive task status information by period/by business classification from the global business management database D, predict a business expense according to a task progress, calculate an estimated expense by using business expense spending information of a similar facility, and analyze financial feasibility of the business.

While promoting a project of a unit facility included in the global business, by providing information about a current status of business expense, a predicted business expense, a financial validity, a business expense execution management, a contract management, a revision control, a business expenses index management, a standard allocation curve, and a cost schedule integrated management, a current progress state of a business expense of a unit facility is determined, a cash flow that reflects various factors may be checked, and a more reliable business expense execution plan may be established.

The business period managing module 500 is configured to receive information of task status by period/by business classification, calculate an estimated business period by using business period information of a similar facility, and optimize a construction schedule plan by receiving the business expense information from the business expense managing module 400 and by calculating expenditures of business expense by construction period.

The business period managing module 500 of the present invention may be used for checking a current task status and a task progressing figure by task period that is predicted therefrom. Meanwhile, while calculating the construction period, in an embodiment, business periods of a plurality of similar facilities among the received business management information from the global business management database D may be extracted and stored. The business period information may be used for calculating an estimated business period by applying the business period information to an Asakura formula.

In order to derive the estimated business period, when a user inputs values corresponding to respective conditional coefficients of the Asakura formula, a construction period of a global business currently under progress may be estimated. The conditional coefficients of the Asakura formula reflect a degree of foundation work, a soil quality, a type of framework, a proposal of a unit facility under construction, etc. and are digitized data thereof. The conditional coefficients of the Asakura formula may be set by reflecting a correction value that reflects resident complaints, materials, equipments, manpower situations, site location, design, timely constraints, traffic, etc.

Accordingly, construction periods of respective unit facility constructions may be estimated, and a construction period of a global business of a program level may be estimated based on the estimated construction periods of respective unit facility constructions. Thus, users who use the construction business management apparatus A and entities that use the web control room server C and the business participant entity system B may predict and manage a business period of the global business.

The electric manual/conflict managing module 100 stores a decision-making situation definition for each task process and a decision-making standard system for each situation that are input by the user in the global business management database D. When a situation where the user has to make a decision occurs or the user has to use information of the standard system for decision-making and the electric manual/conflict managing module 100 receives a request of information about the decision-making situation definition and the decision-making standard system, the electric manual/conflict managing module 100 provides the requested information to a user-verifiable form by receiving the information from the global business management database D.

Meanwhile, hereinafter, the electric manual/conflict managing module 100 of the present invention will be described in detail.

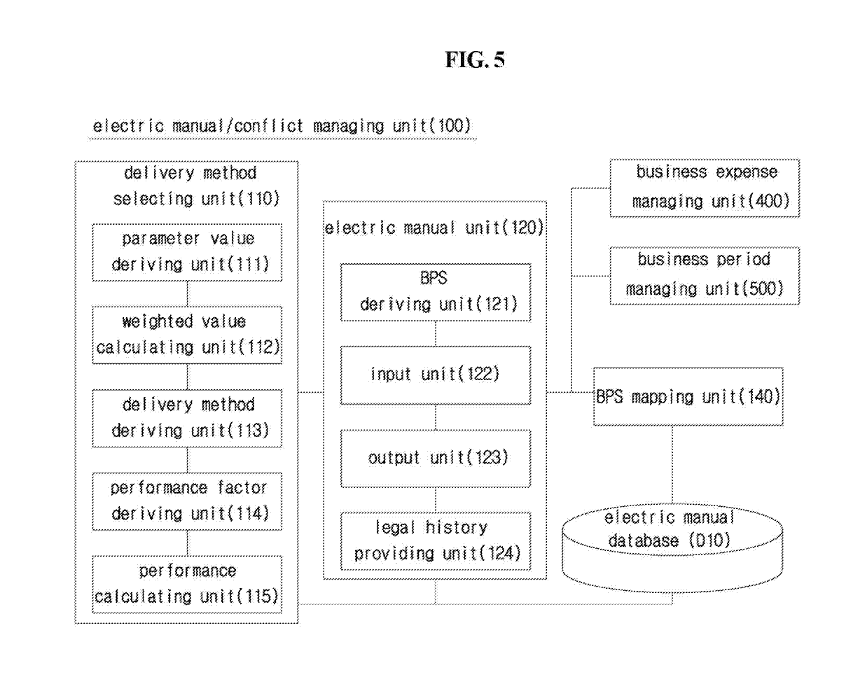

FIG. 5 shows the electric manual/conflict managing module 100 that includes a delivery method selecting unit 110, an electric manual unit 120, and a BPS mapping unit 140. In addition, the global business management database D may include an electric manual database D10 that stores business management information and receives/transmits the business management information from/to the electric manual unit 120, and the global business management system may include a terminal of the business participant entity for inputting business management information to the electric manual/conflict managing module 100 and for outputting performed business management information.

Meanwhile, FIG. 5 is a block diagram showing a detailed configuration of the delivery method selecting unit 110, the electric manual unit 120, and the BPS mapping unit 140 included in the electric manual/conflict managing module 100 of the present invention. In detail, the delivery method selecting unit 110 may include a parameter value deriving unit 111, a weighted value calculating unit 112, a delivery method deriving unit 113, a performance factor deriving unit 114, and a performance calculating unit 115. The electric manual unit 120 may include a BPS deriving unit 121, an input unit 122, an output unit 123, and a legal history providing unit 124.

The electric manual unit 120 derives a task hierarchy in life stages according to delivery method selection information input by an ordering organization, and provides information required for performing a task or performed task information to a corresponding entity.

In detail, the BPS deriving unit 121 of the electric manual unit 120 derives the task hierarchy in life stages to include a ‘planning and programming stage’, a ‘design stage’, a ‘construction order and contract stage’, a ‘construction stage’, and an ‘operation and maintenance stage’ based on a business process breakdown structure (BPS) information stored in the electric manual database D10 according to the delivery method selection information that is input by the ordering organization.

Herein, the BPS deriving unit 121 of the electric manual unit 120 may constitute the task hierarchy in life stages in a first to third levels based on the BPS information stored in the electric manual database D10.

In other words, the BPS may be classified into three levels. In detail, the first level includes a ‘plan and program stage’, a ‘design stage’, a ‘construction order and contract stage’, a ‘construction stage’ and an ‘operation and maintenance stage’ according to the task hierarchy in life stages.

In addition, in one embodiment, the ‘plan and program stage’ of the first level may include a ‘basic concept’, a ‘validity survey’, a ‘basic business plan formulation’, a ‘business execution plan formulation’, a ‘plan stage VE’, a ‘design influencing factors examination’, a ‘designer selection’, a ‘participant selection’, etc. as the second level.

In addition, the ‘basic business plan formulation’ of the second level may include an ‘investigation and decision on business execution method’, a ‘preparation and examination of business execution plan’, an ‘approval of business execution plan’, a ‘preparation and examination of business execution procedure’, an ‘approval of business execution procedure’, and a ‘pre-licensing approval examination’, etc. as the third level.

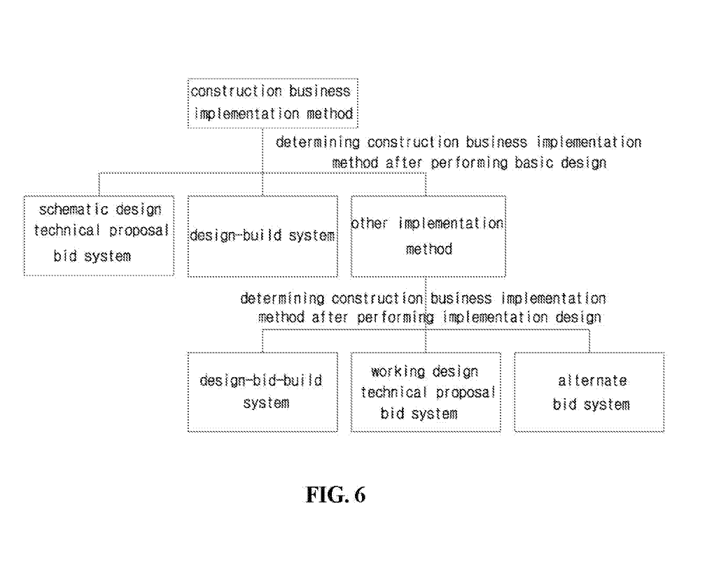

Meanwhile, in the present invention, a characterized BPS according to a delivery method may be derived, as shown in FIG. 6, the delivery method defined in the present invention includes a ‘design-bid-build (DBB) system’, a ‘design-build system (turn-key base)’, an ‘alternate bid system’, a ‘schematic design technical proposal bid system’, and a ‘design technical proposal bid system’.

The delivery method selection information input by the ordering organization may be classified into order information and construction business information. The order information may include an ordering organization experience and financial status, and the construction business information may include a business type, a business period, a business expense, a business area, a purpose, a number of facilities, a business location, etc. More particularly, the construction business information may include a total ground area, a residential area, and a number of households.

In addition, when the construction business is a road, a road extension, a bridge extension, a tunnel extension, etc. may be additionally considered.

Of course, according to circumstances, the ordering organization may directly input the delivery method by pre-selecting any one of the delivery methods.

Meanwhile, the input unit 122 of the electric manual unit 120 may provide information to a responsible entity required for performing a third level task, and receive performed task information performed by the responsible entity and store the information in the electric manual database D10.

For example, while performing a task of the ‘investigation and decision on business execution method’ of the third level, an ‘example analysis’ and a ‘basic plan’ are provided to the ‘ordering organization’ that is the responsible entity as the information required for performing a task.

Herein, the input unit 122 of the electric manual unit 120 may provide among the business management information stored in the database, standardized documents of appropriate forms that are necessary for business execution while proving information required for performing a task. Accordingly, an execution entity may access to the electric manual/conflict managing module 100 through a terminal, and complete the performed task information by performing the information required for performing the task in an appropriate form.

Then, the output unit 123 of the electric manual unit 120 provides the performed task information performed by the responsible entity to any one of the responsible entity, a revising entity, or an assigning entity.

For example, while performing a task of the ‘investigation and decision on business execution method’ of the third level, an ‘example analysis’ and a ‘basic plan’ performed by the ‘ordering organization’ are completed as the performed task information of the ‘business execution method’, and the ‘business execution method’ formed as the performed task information is provided to the ‘ordering organization’ that is the responsible entity without passing any special revising entity, or an assigning entity.

Alternatively, while performing a task of the ‘investigation and decision on business execution method’ of the third level of the ‘construction order and contract stage’ of the first level, a ‘business execution plan’ performed by the ‘ordering organization’ and a ‘construction business manager’ is completed as the performed task information of ‘selected delivery method’. In the ‘selected delivery method’ formed as the performed task information, the ‘ordering organization’ and the ‘construction business manager’ become the responsible entity and the revising entity respectively, and the ‘ordering organization’ becomes the assigning entity.

In addition, while performing a third level task, the ‘business execution method’ of the performed task information is provided as the information required for performing a task of the ‘investigation and decision on business execution method’ so that a task may be continuously performed according to a continuous task procedure.

Meanwhile, the legal history providing unit 124 of the electric manual unit 120 may provide legal information related to performing a third level task.

For example, while performing a task of the ‘deliberation on bidding method for large-scale construction’ and the ‘investigation and decision of construction delivery method’ of the third level of the ‘construction order and contract stage’ of the first level, an execution entity of the corresponding task may receive various kinds of deliberation standards and guidelines for deliberation.

In addition, the legal history providing unit 124 may provide serial numbers, legal names, enforcement dates, task performance entities, manual availabilities, and processes of regulations.

Herein, the legal history providing unit 124 provides information of related regulations and manages relevant regulations to be revised through the electric manual database D10.

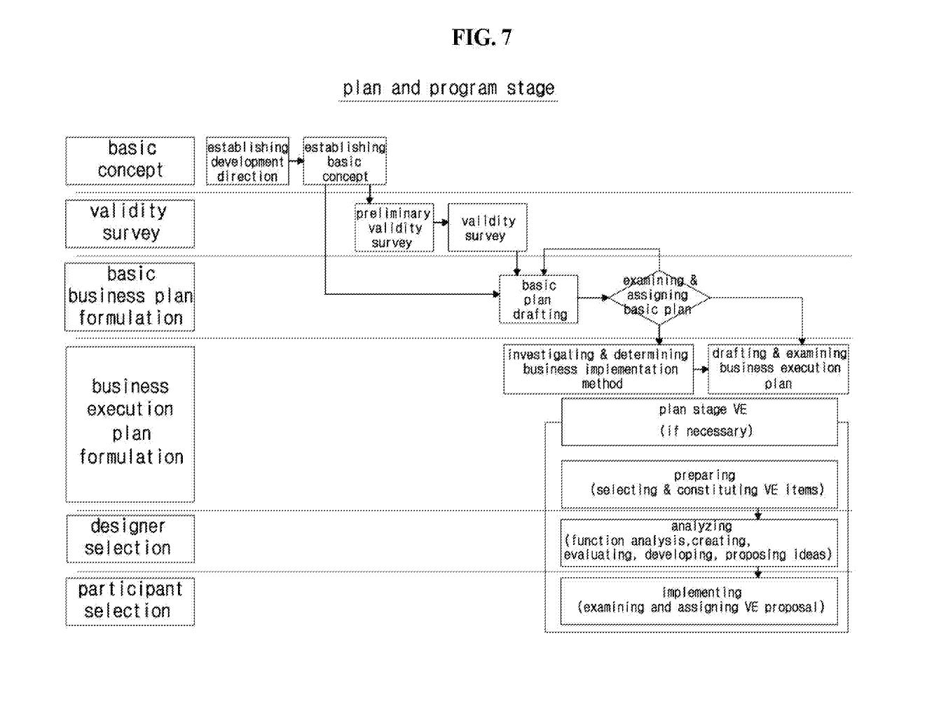

Meanwhile, as shown in FIG. 7, the BPS mapping unit 140 provides visualized information so that a temporal flow the task hierarchy in life stages derived by the electric manual unit 120 can be easily comprehended.

The visualized information provided by the BPS mapping unit 140 is provided to be associated with the BPS. There is an effect an execution entity of corresponding task being able to immediately know where the current task is in terms of the whole project.

In addition, procedures that may be further examined and executed as necessary for the performance of a specific task may be provided in a pop-up form to support more precise task performance.

For example, as shown in FIG. 7, the ‘business execution plan formulation’, the ‘designer selection’, and the ‘participant selection’ of the second level of the ‘plan and program stage’ of the first level may selectively perform the ‘program stage VE’ as performing of a third level task, and inform an execution entity of a corresponding task.

In addition, the visualized information provided by the BPS mapping unit 140 is expressed as arrows so that time flow is instantaneously recognized Different types of arrows may be used to distinguish between tasks that are performed as necessary and tasks that need to be reviewed in such a way that the time flow is reflected.

In addition, when performing a specific third level task is selected in the BPS mapping unit 140, it may be linked so as to be able to perform the third level task related to the specific task.

Meanwhile, the delivery method selecting unit 110 may select any of the ‘design-bid-build system’, the ‘design-build system’, the ‘alternate bid system’, the ‘schematic design technical proposal bid system’ or the ‘design technical proposal bid system’ as the delivery method based on construction project post-evaluation information stored in the electric manual database D10 according to the delivery method selection information input by the ordering organization.

As described above, the delivery method selection information input by the ordering organization may be classified into order information and construction business information. The order information may include an ordering organization experience and financial status, and the construction business information may include a business type, a business period, a business expenses, a business area, a purpose, a number of facilities, a business location, etc. More particularly, the construction business information may include a total ground area, a residential area, and a number of households.

In addition, when the construction business is a road, a road extension, a bridge extension, a tunnel extension, etc. may be additionally considered.

The delivery method selecting unit 110 selects the most appropriate delivery method by using a case-based reasoning (CBR) technique or a logical operation technique based on the construction project post-evaluation information stored in the electric manual database D10.

Meanwhile, in Korea, in accordance with the ‘implementation guideline for post evaluation of construction project’ regulation, business performance, business efficiency and ripple effect are evaluated for construction projects with a total construction expense of over 30 billion won. In addition, data of performances of some domestic large construction projects (construction project post-evaluation information) are collected in ‘Construction CALS Portal System’.

Accordingly, the present invention stores the construction project post-evaluation information in the electric manual database D10 and constantly updates the information to use for selecting a delivery method.

In detail, the parameter value deriving unit 111 of the delivery method selecting unit 110 may derive parameter values of parameter factors of a corresponding business based on the delivery method selection information including the order information and the construction business information.

The parameter factors may refer to delivery method selection information and may be the input order information and construction business information itself. The parameter factors may include an ordering organization experience and financial status, a business type, a business period, a business expense, a business area, a purpose, a number of facilities, a business location, etc. More particularly, the parameter factors may include a total ground area, a residential area, and a number of households. In addition, when the construction business is a road, a road extension, a bridge extension, a tunnel extension, etc. may be additionally considered. In addition, the parameter factors may be abstract factors that are calculated by the delivery method selection information such as innovation, complexity, flexibility, uncertainty, integrity, marketability, economic feasibility, etc.

Meanwhile, the weighted value calculating unit 112 of the delivery method selecting unit 110 calculates degrees of influence of respective parameter factors on selecting the delivery method as weighted values based on the construction project post-evaluation information stored in the electric manual database D10.

The weighted values are relative numerical values indicating the influence of the above parameter factors on selecting the delivery method. It is possible to apply fixed constants as the weighted values, but it is preferable to calculate the weighted values based on the construction project post-evaluation information.

In one embodiment, a weighted value (Gain(X,A)) of any one parameter factor A may be calculated by using the formula below.

$$Gain ( X , A ) = Entropy ( X ) - {\sum }_{v ∈ Values ( A )}^{ } \frac{\vert {X}_{v} \vert}{\vert X \vert} Entropy ( {X}_{v} )$$

$$( Entropy ( X ) = - {\sum }_{i = 1}^{m} {p}_{i} {log}_{2} ( {p}_{i} ) )$$

X Is a sample of training examples

Xv are samples of attribute A's training examples

pᵢ is the proportion of examples in X

When the weighted value of the parameter factor A becomes larger, it may refer that the parameter factor has larger influence on selecting the delivery method, and when the weighted value of the parameter factor A becomes smaller, it may refer that the parameter factor has less influence on selecting the delivery method. In case of ‘Gain(X,A)=0’, it may refer that a corresponding parameter factor has no effect on selecting the delivery method.

Meanwhile, the delivery method deriving unit 113 of the delivery method selecting unit 110 may derive a delivery method of an established business having the highest similarity based on the parameter values of the parameter factors of a corresponding business and calculated weighted values of the parameter factors.

The delivery method deriving unit 113 may select an established business having the highest similarity in the construction project post-evaluation information stored in electric manual database D10 based on the calculated weighted values of the weighted value calculating unit 112, and derive a delivery method of the selected established business as the most appropriate delivery method for a corresponding business.

Meanwhile, the performance factor deriving unit 114 of the delivery method selecting unit 110 may derive a result value of performance factors including at least one of a rate of change in business expense relative to a planned expense, a rate of change in business period relative to a planned period, and a benefit-cost (B/C) ratio of each established business based on the construction project post-evaluation information stored in the electric manual database D10.

In other words, since the performance factor deriving unit 114 may derive performance factors of the established businesses, it is possible to select a more feasible delivery method by selecting the delivery method having the highest similarity in the established business and to further consider a performance of the corresponding construction business based on the performance factors of the established business.

In addition, the performance calculating unit 115 of the delivery method selecting unit 110 may calculate a performance of the established business as an index based on the derived result value of the performance factors and the influence values of the respective performance factors.

The influence values of the performance factors may be defined by using an analytic hierarchy process (AHP) analysis. The AHP analysis is an analysis method that derives preference information of experts by relatively comparing evaluation factors with weighted values of alternatives through a survey.

Herein, a single index may be calculated from the performance of the established business by considering the result value of the performance factors and the influence values of the respective performance factors. In one embodiment, the performance ESDPI may be calculated by using the formula below.

$$ESDPI = \frac{{\sum }_{i = 1}^{n} ( {x}_{i} \times {I}_{i} )}{\frac{1}{n} {\sum }_{i = 1}^{n} {x}_{i}} \times 100 ( {\sum }_{i = 1}^{n} {I}_{i} = 1 )$$

Iₙ=Influence Values of Selecting Project Delivery Method to Performance factors

Xₙ-Achievements of Construction project Performances

For example, when an additional performance factor is further considered while calculating the performance of the established business, a formula for calculating the performance in which four performance factors are considered may be defined as shown in Table I below.

TABLE 1

| | | | Achievement of | |
|---|---|---|---|---|
| | Achievement of | Achievement of | Construction | |
| | Construction | Construction | project Design | |
| Performance | project expense | project period | Period versus | B/C |
| factor | versus Plans (I₁) | versus Plans (I₂) | Plans (I₃) | Ratio (I₄) |
| Influence | 0.414 | 0.193 | 0.094 | 0.299 |
| Value | | | | |

$$ESDPI = \frac{( {x}_{1} \times {I}_{1} ) + ( {x}_{2} \times {I}_{2} ) + ( {x}_{3} \times {I}_{3} ) + ( {x}_{4} \times {I}_{4} )}{( {x}_{1} + {x}_{2} + {x}_{3} + {x}_{4} ) \times \frac{1}{4}} \times 100$$

In other words, in a specific established business, when the index of the above-mentioned performance becomes larger, it refers that the performance of the delivery method of the specific established business becomes more positive.

Therefore, when the delivery method deriving unit 113 of the delivery method selecting unit 110 derives different delivery methods of established businesses, the delivery method deriving unit 113 selects a delivery method of an established business with the larger performance based on the indexes calculated by the performance calculating unit 115.

Meanwhile, the electric manual/conflict managing module 100 may interwork with the business expense managing module 400 and the business period managing module 500 that are described above. The business expense managing module 400 and the business period managing module 500 may interwork with the electric manual unit 120 to manage business expenses and business periods according to each task performing of each third level task of the BPS, so that it may provide convenience in terms of progress management.

In detail, it is possible to derive not only a current process rate of the whole schedule, but also process rates according to performing of tasks at respective levels of each stage. In addition, the rates may be also derived from the aspect of the business expense or the business period.

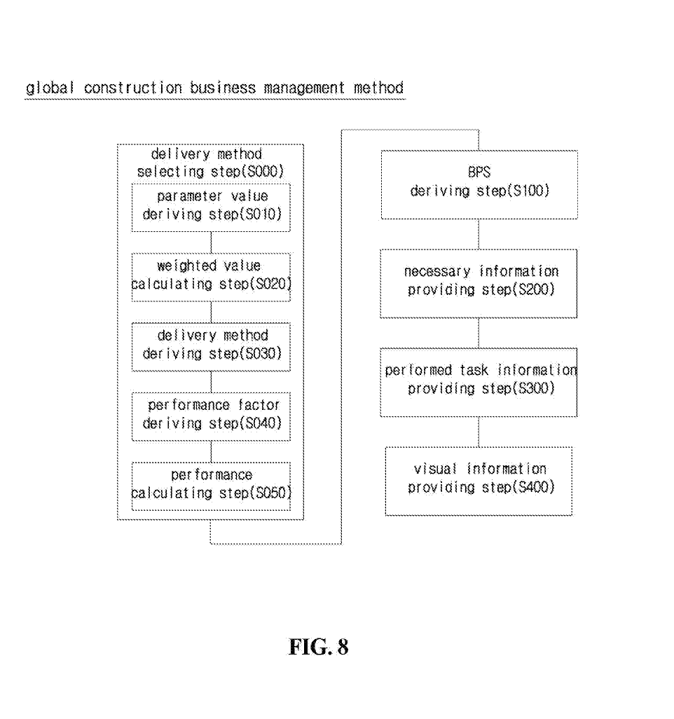

Meanwhile, as shown in FIG. 8, a global construction business management method according to the present invention may include a BPS deriving step S100, a necessary information providing step S200, and a performed task information providing step S300.

In detail, the BPS deriving step S100 is performed by the electric manual unit 120 and derives a task hierarchy in life stages to include a ‘plan and program stage’, a ‘design stage’, a ‘construction order and contract stage’, a ‘construction stage’, and an ‘operation and maintenance stage’ based on BPS information stored in the electric manual database D10 according to delivery method selection information input by an ordering organization.

Herein, the BPS deriving unit 121 of the electric manual unit 120 may constitute the task hierarchy in life stages in a first to third levels based on the BPS information stored in the electric manual database D10. The first level includes: a ‘plan and program stage’; a ‘design stage’; a ‘construction order and contract stage’; a ‘construction stage’; and an ‘operation and maintenance stage’ according to the task hierarchy in life stages.

In the necessary information providing step S200 that is progressed after the above step, the electric manual unit 120 provides to a responsible entity information required for performing a task.

The input unit 122 of the electric manual unit 120 may provide standardized documents that are necessary for business execution among the business management information stored in the electric manual database D10. Accordingly, an execution entity may access to the electric manual/conflict managing module 100 through a terminal, and complete performed task information by inputting in an appropriate form the information required for performing a task.

Meanwhile, in the necessary information providing step S200, the electric manual unit 120 may provide legal information related to performing a task.

The legal history providing unit 124 of the electric manual unit 120 provides information of related regulations and manages relevant regulations to be revised by using the electric manual database D10.

In addition, in the performed task information providing step S300, the electric manual unit 120 provides performed task information that is performed by the responsible entity to any one of the responsible entity, a revising entity, or an assigning entity.

Meanwhile, the global construction business management method of the present invention may further include a visual information providing step S400, performed by the BPS mapping unit 140, of providing visualized information so that a temporal flow the task hierarchy in life stages derived by the electric manual unit 120 can be easily comprehended.

The visualized information provided by the BPS mapping unit 140 is provided to be associated with the BPS. There is an effect an execution entity of a corresponding task of being able to immediately know where the current task is in terms of the whole project Procedures that may be further examined and executed as necessary for a performance of a specific task may be provided in a pop-up form to support more precise task performance.

Meanwhile, the global construction business management method of the present invention may further include a delivery method selecting step S000, performed by delivery method selecting unit 110, of selecting many one of a ‘design-bid-build system’, a ‘design-build system’, an ‘alternate bid system’, a ‘schematic design technical proposal bid system’, or a ‘working design technical proposal bid system’ as a delivery method based on construction project post-evaluation information stored in the electric manual database D10 according to the delivery method selection information input by the ordering organization.

Herein, the delivery method selecting step S000 may include a parameter value deriving step S010, a weighted value calculating step S020, and a delivery method deriving step S030.

In the parameter value deriving step S010, the delivery method selecting unit 110 derives parameter values of parameter factors of a corresponding business based on the delivery method selection information including order information and construction business information.

Herein, the parameter factors may refer to delivery method selection information, and may be the input order information and construction business information itself. The parameter factors may include an ordering organization experience and financial status, a business type, a business period, a business expenses, a business area, a purpose, a number of facilities, a business location, etc. More particularly, the parameter factors may include a total ground area, a residential area, and a number of households.

In addition, when the construction business is a road, a road extension, a bridge extension, a tunnel extension, etc. may be additionally considered. In addition, the parameter factors may be abstract factors that are calculated by the delivery method selection information such as innovation, complexity, flexibility, uncertainty, integrity, marketability, economic feasibility, etc.

Meanwhile, in the weighted value calculating step S020, the delivery method selecting unit 110 calculates degrees of influence of respective parameter factors on selecting the delivery method as weighted values based on the construction project post-evaluation information stored in the electric manual database D10.

As described above, the weighted values are relative numerical values indicating the influence of the above parameter factors on selecting the delivery method. It is possible to apply fixed constants as the weighted values, but it is preferable to calculate the weighted values based on the construction project post-evaluation information.

In addition, in the delivery method deriving step S030, the delivery method selecting unit 110 derives a delivery method of an established business having the highest similarity based on the parameter values of the parameter factors of the corresponding business and derived weighted values of the parameter factors.

The delivery method deriving unit 113 of the delivery method selecting unit 110 may select an established business having the highest similarity in the construction project post-evaluation information stored in electric manual database D10, and derive a delivery method of the selected established business as the most appropriate delivery method for a corresponding business.

Meanwhile, the delivery method selecting step S000 may further include a performance factor deriving step S040 or a performance calculating step S050 or both.

In the performance factor deriving step S040, the delivery method selecting unit 110 derives a result value of an performance factor of the established business including at least one of a rate of change in business expense relative to a planned expense, a rate of change in business period relative to a planned period, and a B/C ratio of each established business based on the construction project post-evaluation information stored in the electric manual database D10.

Since the performance factor deriving unit 114 of the delivery method selecting unit 110 may derive performance factors of the established business, it is possible to select a more feasible delivery method by selecting the delivery method having the highest similarity in the established business and further to consider a performance of the corresponding construction business based on the performance factors of the established business.

In addition, in the performance factor deriving step S040, the delivery method selecting unit 110 calculates a performance of the established business as an index based on the derived result value of the performance factors that are derived by the delivery method selecting unit 110 and influence values of the respective performance factors.

When the index of the above-mentioned performance becomes larger, it may refer that the performance of the delivery method of the specific established business is more positive. Accordingly, when the delivery method deriving unit 113 derives different delivery methods of established businesses, the delivery method deriving unit 113 may select a delivery method of an established business having the larger performance based on the indexes calculated by the performance calculating unit 115.

The risk/performance managing module 300 is configured to receive response strategies associated with risk factors from a user, establish standard response strategies and response strategies that are generated by reflecting previous risk factors, and check a performance value based on a performance index of each task process of the business.

The risk/performance managing module 300 checks risk values that are measured by each task process for progressing the business of each unit facility within the global business, and provides risk response strategy based on the risk values. The risk/performance managing module 300 receives the risk response strategy and displays it to the user. For example, when the risk checked by the measured risk value in the task process is ‘Insufficient in policy/regulation/system examination’, in response to the risk, as response strategies, ‘A. Finding a business organization and a structure by grasping legal constraints’, B. ‘Reviewing contract methods and contracts by legal system’, C. ‘Order system and ordering method by legal system’ may be provided, and new response strategies for the current risk may be established based on the provided response strategies.

The eco-friendly value engineering/life cycle cost analysis module 200 is configured to retrieve and receive a standard value engineering/life cycle cost analysis stored in the global business management database D, adjust items of the standard value engineering/life cycle cost analysis according to a user's selection, and analyze a life cycle cost (LCC) by receiving data that meets the adjusted items from the user.

Meanwhile, hereinafter, the eco-friendly value engineering/life cycle cost analysis module 200 of the present invention will be described in detail.

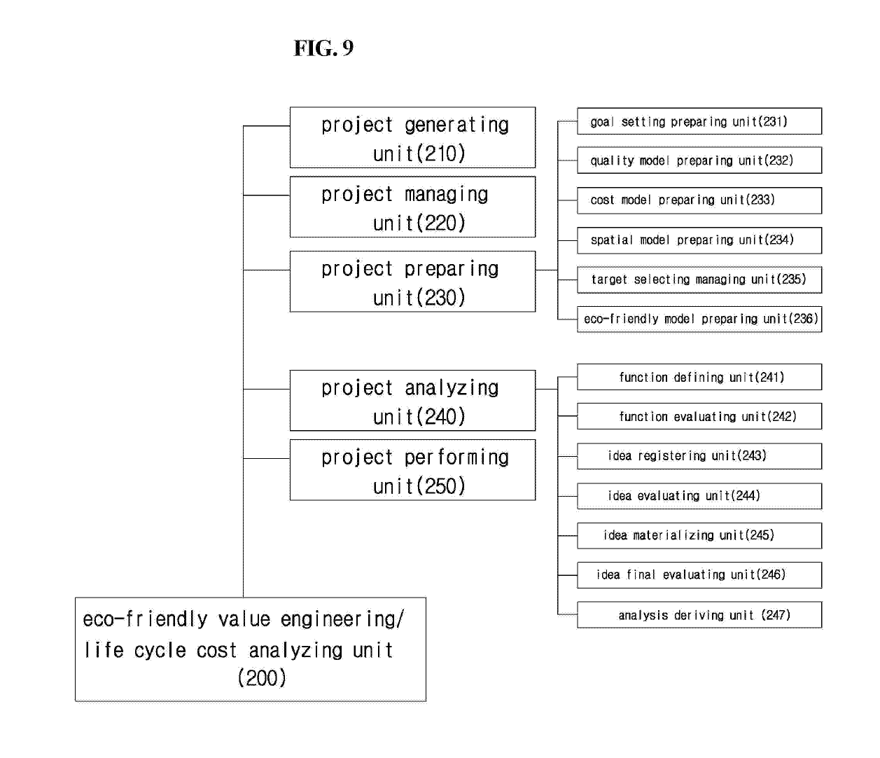

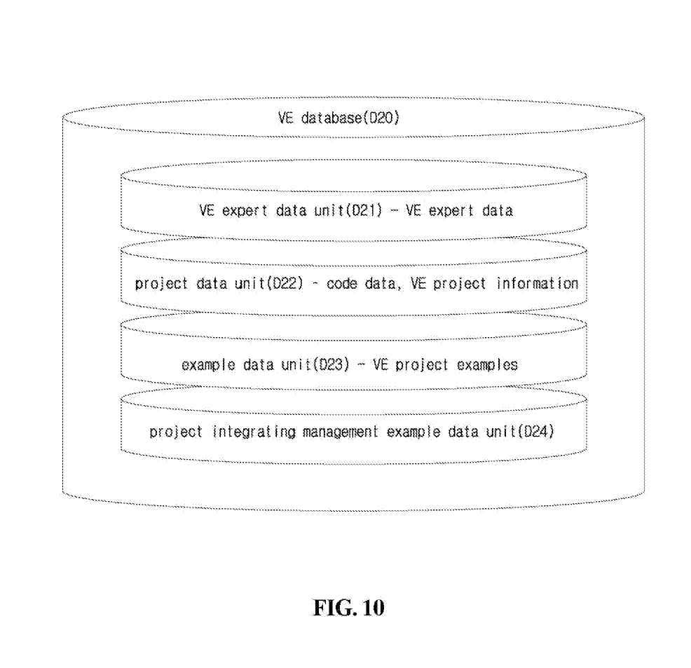

As shown in FIG. 9, the eco-friendly value engineering/life cycle cost analysis module 200 may include a project generating unit 210, a project managing unit 220, a project preparing unit 230, a project analyzing unit 240, and a project performing unit 250. In accordance with this, the global business management database D may include a VE database D20 as shown in FIG. 10, the VE database D20 may include a VE expert data unit D21, a project data unit D22, and an example data unit D23.

The VE expert data unit D21 of the VE database D20 stores VE expert data by construction sector, and provides a team leader and team members that will be input to the project generating unit 210 and the project managing unit 220 that will be described later.

In addition, the project data unit D22 stores code data and VE project information that is processed by the eco-friendly value engineering/life cycle cost analysis module 200. The project data unit D22 may include standard classification systems such as promoting state classification system, expense classification system, spatial model classification system, construction information classification system, etc. that may be input to the project peparing unit 230 that will be described later.

Meanwhile, construction projects may be classified into: a plan design stage, a program design stage, a basic design stage, an implementation stage, a construction stage, and a maintenance stage. A conventional construction value engineering (VE) does not consider features of respective stages of a life cycle of a project as described above, effectiveness is low and accuracy is reduced since there is no way to share data between stages although each project example is datafied.

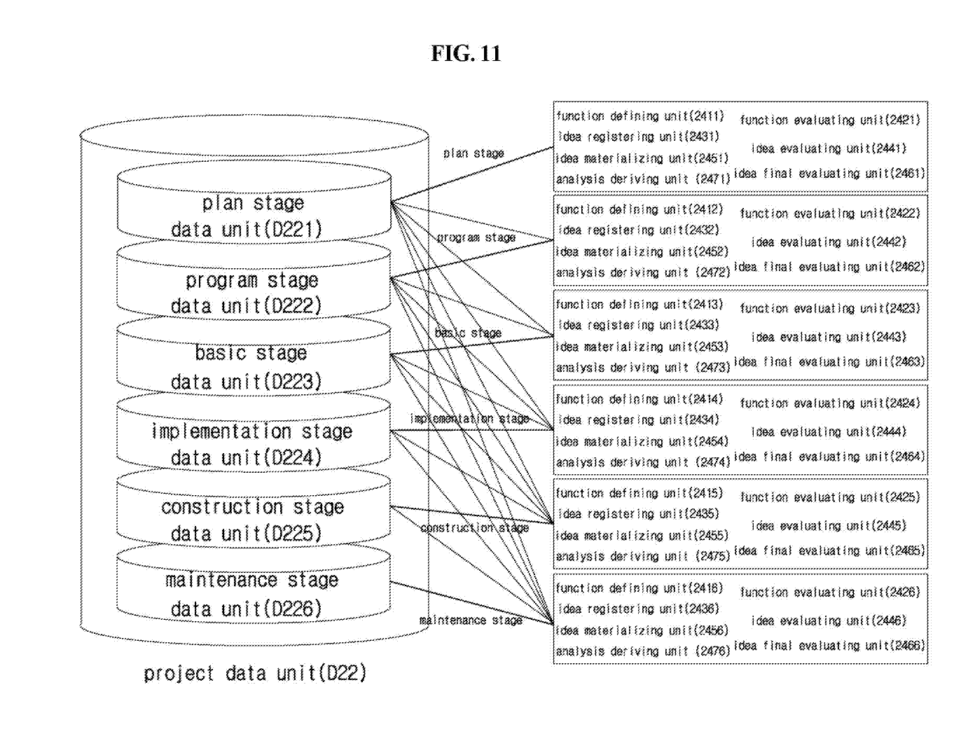

In order to solve the above problems, as shown in FIG. 11, the project data unit D22 may include a plan stage data unit D221, a program state data unit D222, a basic stage data unit D223, an implementation stage data unit D224, a construction stage data unit D225, and a maintenance management data unit D226 such that the project data unit D22 stores VE project information by project stage.

The example data unit D23 stores VE project examples, and retrieves and analyzes similar examples based on VE project examples that are previously executed as an example of a spatial model preparing unit 233 of the project preparing unit 230 that will be described later.

Meanwhile, the project generating unit 210 of the eco-friendly value engineering/life cycle cost analysis module 200 generates a new VE project by receiving a team leader input selected by the VE expert data that is provided by the VE expert data unit D21.

In addition, the project managing unit 220 manages a project by receiving team member input by sector selected by the VE expert data that is provided by the VE expert data unit D21 and by receiving input of project information and a schedule plan thereof.

The team leader selected by the project generating unit 210 may autonomously access the project managing unit 220 and mange the project. The team members selected by the project managing unit 220 may access to the eco-friendly value engineering/life cycle cost analysis module 200 as managers.

In addition, in order to input project information, the project managing unit 220 may receive input of project information that is related to a project outline such as business name, business period, purpose, building area, plottage, total ground area, or site location.

The project managing unit 220 may receive input such as ‘planned start date’, ‘planned end date’, ‘actual start date’, ‘actual end date’, etc. according to a promoting stage classification system provided by the project data unit D22.

In addition, since the construction project may be classified into a plan design stage, a program design stage, a basic design stage, an implementation design stage, a construction stage, and a maintenance management stage, the project managing unit 220 may receive the input according to above stages to implement a detailed schedule plan.

Meanwhile, the project preparing unit 230 prepares the project by receiving eco-friendly goal input of the project and by receiving expert evaluation input of eco-friendly items of the project that are provided by project data unit D22.

Herein, the eco-friendly goals of the project that are input to the project preparing unit 230 may include a system grade of at least one of an eco-friendly building certification system, a building energy efficiency level certification system, an energy saving design standard system for buildings, and a renewable energy mandatory system of public institutions.

Accordingly, it is possible to actively seek out ways to create a comfortable indoor environment without creating an adverse effect on the external natural environment or on human beings, and with using energies in harmony with the external environment, as a building itself.

Meanwhile, as shown in FIG. 9, the project preparing unit 230 may include a goal setting preparing unit 231, a quality model preparing unit 232, a cost model preparing unit 233, a spatial model preparing unit 234, a target selecting managing unit 235, and an eco-friendly model preparing unit 236.

The goal setting preparing unit 231 receives eco-friendly goal input of the project, and expenses, functions, or values may be input as additional goals instead of system grades of an eco-friendly building certification system, a building energy efficiency level certification system, an energy saving design standard system for buildings, and a renewable energy mandatory system of public institutions.

The quality model preparing unit 232 receives input of selected quality model items provided by the project data unit D22, and analyzes demands of the quality model items by receiving expert evaluation input of the selected quality model items.

As the quality model items provided by project data unit D22, a ‘use stability’, a ‘need for facilities’, a ‘maintenance of facilities’, an ‘accordance with surrounding area’, a ‘scenery and comfort’, an ‘ease of material procurement’, a ‘civil complaint prevention’, a ‘traversability procure’, a ‘vegetation suitability’, an ‘economic feasibility’, a ‘stability during use’, a ‘maintainability’, etc. may be included A manager may select main quality model items.

Then, for the selected quality model items, demands of the quality model items are analyzed by receiving expert evaluations such as construction inspection company, ordering organization, designer, constructor, etc. and by inputting evaluation values thereof.

In addition, the cost model preparing unit 233 analyzes management targets by task type by receiving costs of cost model items provided by project data unit D22.

By inputting costs by task type provided by the project data unit D22, a task type that will be the main management target will be analyzed. As the task type, architecture, civil engineering, construction, machinery, electricity, telecommunications, or a fire fighting may be included.

The spatial model preparing unit 234 analyzes management targets by space by receiving input of project information of spatial model items provided by the project data unit D22.

By inputting areas of the spatial model items provided by the project data unit D22, spatial model items that will be the main management target will be analyzed. As the spatial model items, a ‘residential space’, a ‘public space’, a ‘convenience space’, a ‘corridor/stairway’, a ‘parking space’ or an ‘other space’ may be included.

Meanwhile, the spatial model preparing unit 234 may analyze the management targets by space by receiving project information of the spatial model items provided by the project data unit D22 and by retrieving similar examples based on the VE project example of the example data unit D23.

Accordingly, the more diverse the VE project examples are, the more concrete and accurate analysis of management targets by space becomes.

In addition, the target selecting managing unit 235 receives input of a selected construction information classification system provided by project data unit D22. The construction information classification system refers to an upper class and may be classified into: a residential facility, a commercial facility, a business facility, etc. Respective lower classes thereof may be selected by further subdividing into subcategories.

For example, the business facility may be subdivided into subcategories such as ‘work space’, ‘public space’, ‘parking space’, ‘convenience space’, etc. The ‘work space’ may be subdivided into subcategories such as ‘ceiling’, ‘wall’, ‘floor’, ‘window’, ‘door’, etc. Thus, the management targets may be selected in the lowest classification unit.

The eco-friendly model preparing unit 236 analyzes the demands of the eco-friendly items provided by the project data unit D22.

In detail, as the eco-friendly items of the project provided by the project data unit D22, a ‘land use’, a ‘transportation’, ‘energy’, ‘materials and resources’, ‘water resources’, a ‘pollution prevention’, a ‘maintenance’, an ‘ecological environment’, an ‘indoor environment’, etc. may be included. Each item may be subdivided into subcategories. The demands of the eco-friendly items may be analyzed by inputting expert evaluation values of the lowest classification unit.

For example, the ‘land use’ item is subdivide into subcategories such as ‘ecological value’, ‘influence on neighboring land’, etc. and the ‘ecological value’ may include an ‘ecological value of existing land’ as the lowest classification unit.

Meanwhile, the project analyzing unit 240 analyzes functional improvement targets by receiving project function input and by receiving expert evaluation input of the input project functions, and analyzes a life cycle assessment (LCA) by receiving project idea input, receiving expert evaluation input of the input project ideas, and receiving project proposal input.

LCA is an abbreviation of a life cycle assessment and is an analysis of the environmental impacts across production, distribution, and disposal, such as consumption of raw materials and energy, generation of pollutants and waste, etc. An eco-friendly value of the project may be derived through the above LCA analysis.

Energy consumption and CO₂ emission quantities between before improvement and after improvement may be compared and analyzed based on the ideas and the functions of the project.

Herein, the project analyzing unit 240, as shown in FIG. 10, may include a function defining unit 241, a function evaluating unit 242, an idea registering unit 243, an idea evaluating unit 244, an idea materializing unit 245, an idea final evaluating unit 246, and an analysis deriving unit 247.

The function defining unit 241 receives input of project functions according to the construction information classification system and arranges the input projection functions.

The functions may be defined by system for the construction information classification system that is analyzed by the target selecting managing unit 235 of the project preparing unit 230.

In detail, for the ‘ceiling’ of the ‘work space’ that is the lower class of the business facility, a target and a function may be defined in a format by using a subject and verb such as ‘Providing a comfortable working space’, etc.

In addition, each of the defined functions may be organized by a time, a reason, and a method by arranging the functions in a diagram form.

The function evaluating unit 242 analyzes functional improvement targets by receiving expert evaluation input of the input project functions. Herein, the expert evaluation may include an outline evaluation of the function. In detail, whether the idea is simple, whether the idea is unnecessary, whether there has an effect on cost reduction and on quality improvement may be determined.

The function evaluating unit 242 may analyze the functional improvement targets by using a forced decision (FD) method that is evaluated as ‘0’ or ‘1’, by using an improved weight decision method (IWDM) method that is evaluated by reflecting importance and correction value after the FD method, and by using a value mismatch method that is evaluated by reflecting cost and function importance after the IWDM method.

In addition, the function evaluating unit 242 may separately select the analyzed functional improvement targets and transmit the selected targets to the project performing unit 250 so that the selected targets may be provided in a report format.

The idea registering unit 243 receives input of the project ideas according to the construction information classification system. The ideas may be registered by function of functional improvements target of the construction information classification system that is analyzed by the function evaluating unit 242.

The ideas may be input by selecting ideas stored in the example data unit D23, or may be directly input.

The idea evaluating unit 244 selects ideas by receiving expert evaluation input of the input project ideas. For the ideas that are registered by the idea registering unit 243, a ‘need for facility’, a ‘maintenance of facility’, an ‘accordance with surrounding area’, etc. may be evaluated.

The idea materializing unit 245 receives input of materialized ideas of the selected project ideas. For example, when the idea is ‘Replacing sound absorbing material’, the idea may be materialized as ‘Replacing with wood sound absorbing material’.

The materialized ideas may be input by selecting materialized ideas stored in the example data unit D23, or may be directly input.

The idea final evaluating unit 246 finally selects ideas by receiving expert evaluation input of the materialized ideas. The ideas may be finally selected by inputting examination items, a person in charge, and a result of the materialized idea.

The analysis deriving unit 247 analyzes an LCA by receiving project proposal input based on the finally selected ideas. The project proposals are input content of before improvement and after improvement of the finally selected ideas. The contents may be locations, images, features, and effects, etc. A result of the LCA of before improvement and after improvement may be analyzed based on the project proposals.

Meanwhile, as shown in FIG. 11, the project analyzing unit 240 may receive input of project functions by project stage, analyzes functional improvement targets by receiving expert evaluation input of the input project functions, and analyze an LCA by receiving project ideas, receiving expert evaluation input of the input project ideas, and receiving project proposal input.

In detail, the function defining unit 241 of the project analyzing unit 240 may include a plan stage function defining unit 2411, a program stage function defining unit 2412, a basic stage function defining unit 2413, an implementation stage function defining unit 2414, a construction stage function defining unit 2415, and a maintenance stage function defining unit 2416.

Accordingly, project functions that are defined by each stage are respectively stored in a plan stage data unit D221, a program stage data unit D222, a basic stage data unit D223, an implementation stage data unit D224, a construction stage data unit D225, and a maintenance stage data unit D226.

Herein, the functions defined in the plan stage function defining unit 2411 are continuously provided to the program stage function defining unit 2412, the basic stage function defining unit 2413, the implementation stage function defining unit 2414, the construction stage function defining unit 2415, and the maintenance stage function defining unit 2416 that are the following stages as information to be used for helping to review and derive improvements at a later stage.

Meanwhile, the function evaluating unit 242 may include a plan stage function evaluating unit 2421, a program stage function evaluating unit 2422, a basic stage function evaluating unit 2423, an implementation stage function evaluating unit 2424, a construction stage function evaluating unit 2425, and a maintenance stage function evaluating unit 2426.

Accordingly, function evaluation data that is defined by stage of the project is stored in plan stage data unit D221, a program stage data unit D222, a basic stage data unit D223, an implementation stage data unit D224, a construction stage data unit D225, and a maintenance stage data unit D226 of the project data unit D22.

In addition, with the same principle, the idea registering unit 243 may include a plan stage idea registering unit 2431, a program stage idea registering unit 2432, a basic stage idea registering unit 2433, an implementation stage idea registering unit 2434, a construction stage idea registering unit 2435, and a maintenance stage idea registering unit 2436. The idea evaluating unit 244 may include a plan stage idea evaluating unit 2441, a program stage idea evaluating unit 2442, a basic stage idea evaluating unit 2443, an implementation stage idea evaluating unit 2444, a construction stage idea evaluating unit 2445, and a maintenance stage idea evaluating unit 2446.

Hereinafter, the idea materializing unit 245, the idea final evaluating unit 246, and the analysis deriving unit 247 may process VE project information by stage of the project with the same principle. The VE project information by stage is stored in the plan stage data unit D221, the program stage data unit D222, the basic stage data unit D223, the implementation stage data unit D224, the construction stage data unit D225, and the maintenance stage data unit D226 of the project data unit D22 as described above.

Meanwhile, recently, although construction businesses have become larger, construction value engineering (VE) is only performed on each project unit, and it is not possible to integrate and manage a number of projects. This, there is a limit in setting common goals or sharing information for a number of projects related to a single program.

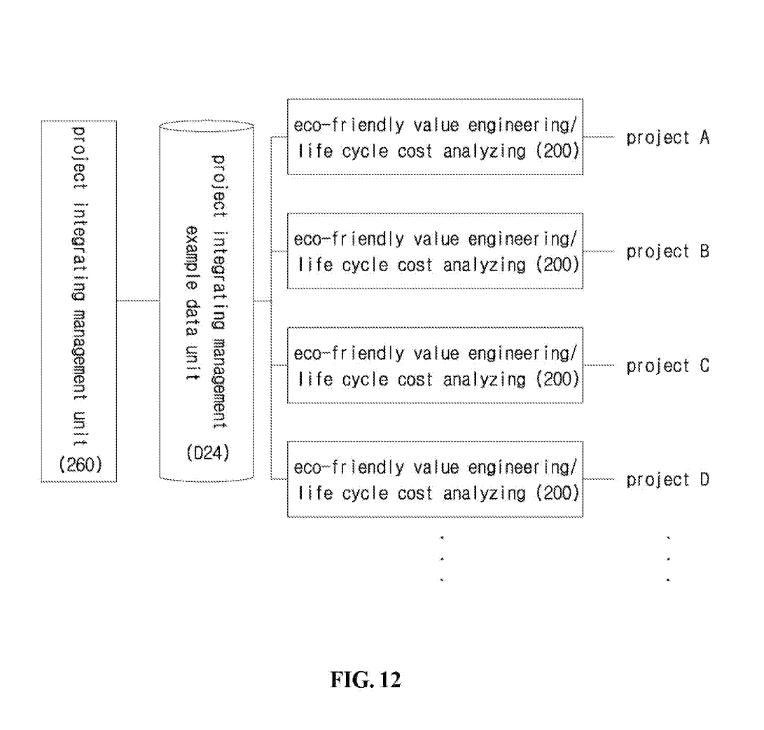

Accordingly, as shown in FIG. 12, the eco-friendly engineering/life cycle cost analysis unit 200 of the present invention may further include a project integrating management unit 260 that selects a plurality of projects for integrally performing and managing construction value engineering.

Herein, the VE project information that is processed by the project managing unit 220, the project preparing unit 230, or the project analyzing unit 240 of each project is stored in the project data unit D22 and in a project integrating management example data unit D24.

Accordingly, since the plurality of projects that is integrated and managed by the project integrating management unit 260 is capable of sharing VE project information from the project integrating management example data unit D24, it may be possible for the plurality of projects that are related to a program to set common goals or share information. Thus, each project is able to create more creative and practical results.

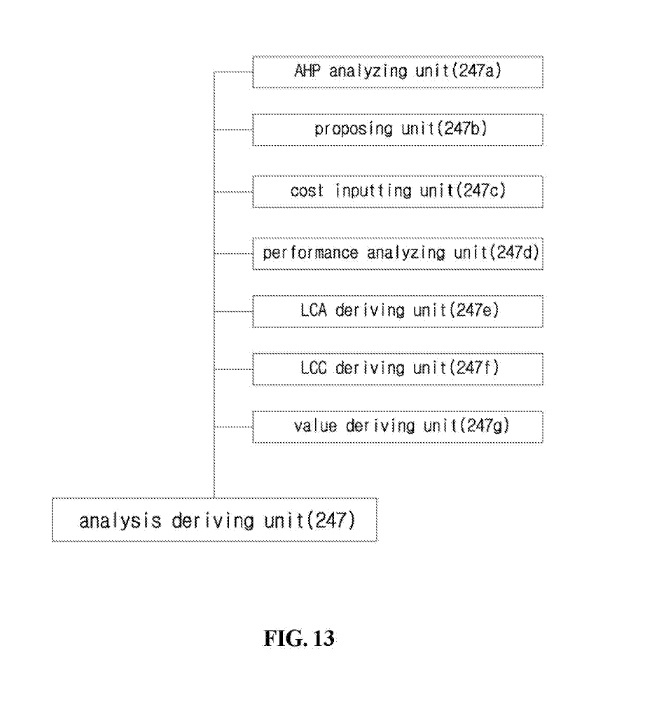

Meanwhile, as shown in FIG. 13, the analysis deriving unit 247 may include an AHP analyzing unit 247a, a proposing unit 247b, a cost inputting unit 247c, a performance analyzing unit 247d, an LCA deriving unit 247e, an LCC deriving unit 247f, and a value deriving unit 247g.

In detail, the AHP analyzing unit 247a evaluates a relative importance by receiving weighted value input of selected quality model items provided by the project data unit D22 through a manager's terminal.

After inputting the weighted values of the quality model items selected by quality model preparing unit 232 of the project preparing unit 230, when a reliability index indicates fit, the analysis is validated.

Herein, the AHP analyzing unit 247a may be included in the performance analyzing unit 247d that will be described later to be configured to be a part of setting a weighted value while analyzing performance.

The proposing unit 247b receives project proposal input based on finally selected ideas through the manager's terminal.

By inputting content of before improvement and after improvement of the finally selected ideas, locations, images, features, and effects may be additionally described.

The cost inputting unit 247c receives cost value input based on the project proposals through the manager's terminal. The input cost values may include an initial construction cost, a maintenance cost, or an energy cost Herein, the maintenance cost may be applied as a parameter for deriving an LCC value derived by the LCC deriving unit 247f by inputting an ‘analysis period’ and a ‘discount rate’.

The performance analyzing unit 247d receives expert evaluations input of the quality model items in which the weighted values are applied through the manager's terminal and evaluates the quality model items. The AHP analyzing unit 247a derives an average value of the quality model items in which the weighted values are applied, and displays the average value by imaging thereof.

Meanwhile, the LCA deriving unit 247e analyzes an LCA based on the project proposals. Result values such as CO₂ emission quantity, energy consumption, etc. of before improvement and after improvement of the ideas may be derived, and the result values may be displayed by being imaged.

The LCC deriving unit 247f analyzes an LCC based on the project proposals and the cost values. Cost values of before improvement and after improvement of the ideas may be compared and derived.

In addition, the value deriving unit 247g derives a global eco-friendly value analysis result based on the VE project information of the performance analyzing unit 247d, the LCA deriving unit 247e, and the LCC deriving unit 247f. Result values of the performance analyzing unit 247d, the LCA deriving unit 247e, and the LCC deriving unit 247f may be globally compared, and used for deriving a value type result, and the derived value type result may be displayed by being imaged.

Meanwhile, the project performing unit 250 provides the VE project information processed by the project managing unit 220, the project preparing unit 230, or the project analyzing unit 240 and stored in project data unit D22 to the manager.

The processed VE project information required by the manager may be selected and provided in a report format. In detail, the project performing unit 250 receives selections of VE project information processed by the project managing unit 220, the project preparing unit 230, or the project analyzing unit 240 and stored in the project data unit D2, and provides the selected information in a report format.

The project performing unit 250 may provide VE project information stored in the plan stage data unit D221, the program stage data unit D222, the basic stage data unit D223, the implementation stage data unit D224, the construction stage data unit D225, and the maintenance stage data unit D226 of the project data unit D22 to a user by project stage.

Meanwhile, the visualization implementation module 600 is a configuration for implementing information that is processed in each unit of the construction business management apparatus A and displayed to the user in a form that the user may confirm. Particularly, the visualization implementation module 600 may define a structure (defining the business based on visualization) that shows which projects constitute a program configured with a number of projects, simulate construction facilities based on shape data, and define details such as finishes of spaces according to a user's input by using the visualization implementation module 600.

In addition, the contract managing module 700 is configured to receive information of licensing by stage and contracts that are stored in the global business management database D, and store contract related information including contract documents and evidential materials in the global business management database D by receiving from a user.

While constructions of unit facilities are in progress, and a global business requires contracts with various entities and needs access to various contents according to progresses of the construction, the contract managing module 700 of the present invention provides information of licensing by performing stage and contracts, and document forms therefor to the user, receives contract documents or evidential materials that are completed based on the provided forms and stores them in the global business management database D. Accordingly, while the business progresses it is possible to guide required contract contents to the user so that appropriate contracts may be processed.

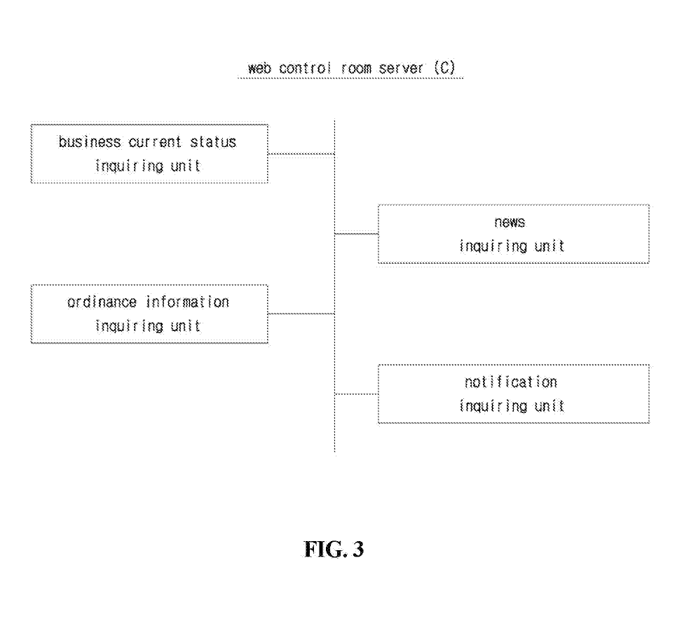

FIG. 3 is a block diagram schematically showing an internal configuration of the web control room server C of the present invention.

The web control room server C of the present invention includes: a business current status inquiring unit that displays business management information of a plurality of business participant entities or a plurality of unit facilities and is received from the global business management database D according to a business manager's selection; an ordinance information inquiring unit that displays information of global business related ordinances received from an ordinance information database; a news inquiring unit that retrieves news related to an urban regeneration global business by keyword/by category, receives the retrieved news from a press database, and displays the received news; and a notification inquiring unit that displays notifications related to the urban regeneration global business by receiving the notification from government departments.

As described above, a government institute or institute that directs the global business operates the web control room server C and are users thereof. Therefore, the government institute or institute receives business management information that is processed in the global business management database D through the construction business management apparatus A and the business participant entity system B, and reflects policies and plans of the government institute or institute on progressing each global business and unit facilities thereof.

In addition, as a public institute, the government institute or other institute may include a configuration that provides information within the scope of disclosure to the public, and for this, a configuration that announces ordinance information, news, national policies that are related to the global business is included therein.

The business current status inquiring unit of the web control room server C of the present invention provides a business period, a business expense, and business management information to whomever has an authority to view the corresponding information according to login information. Since a web page of the web control room server C is configured with contents that are provided to the public, the web page can be viewed by anyone regardless of login information.

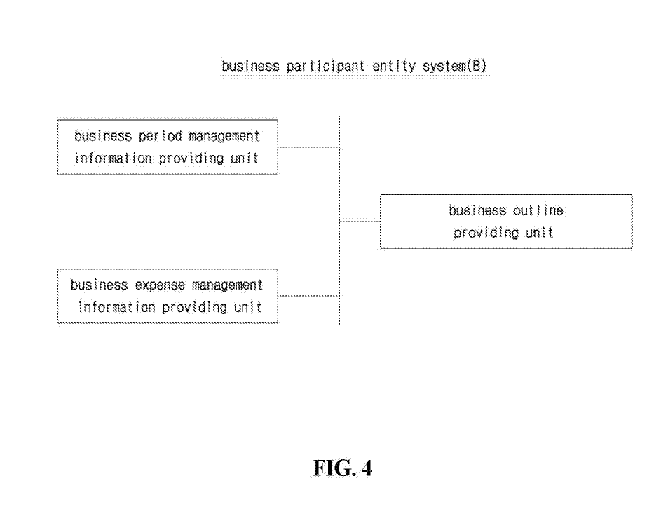

FIG. 4 is a block diagram schematically showing an internal configuration of the business participant entity system B of the present invention.

The business participant entity system B of the present invention includes: a business period management information providing unit that extracts and provides task status information by business period and by facility classification from the business management information of the plurality of unit facilities received from the global business management database ID, a business expense management information providing unit that extracts and provides an execution history of business expenses and an execution plan of business expenses by business classification/by business period/by facility classification, or contract contents by business classification/by business name from the business management information of the plurality of unit facilities received from the global business management database D, a performance management providing unit that analyzes and checks a performance value by task process by analyzing the business management information received from the global business management database; and a business outline providing unit that extracts outlines (including business name, business period, business expense, and air view) of the plurality of unit facilities from the business management information received from the global business management database D and compares and displays the extracted outlines by unit facility.

As mentioned above, the entity such as a local government that manages the global business receives the business management information through the business participant entity system B. Therefore, the local government or the equivalent institution receives information of global businesses that are conducted under the corresponding local government, checks whether or not the global businesses meet regulations and plans of the local government and future progress of the global businesses. In addition, based on this, the local government or the equivalent institution may mange and evaluate each global business.

The business outline providing unit of the business participant entity system B of the present invention is configured with an interface so that a business status and a business outline may be confirmed at a glance. The global business may be effectively managed by using information that is provided by the business period management information providing unit, the business expense management information providing unit, and the business outline providing unit.

Meanwhile, since the global construction business management apparatus, the global business management database, the business participant entity system, and the web control room server of the global business management system of the present invention are interlocked with each ether through a cloud computing system, even though each configuration does not store or update additional data, all configurations of the system may receive updated information when any one of the above configuration of the system updates the business management.

It will be appreciated by those of ordinary skill in the art that the present invention may be embodied in other specific forms without departing from the spirit and essential characteristics of the present invention. Therefore, the embodiments described above are to be understood as merely illustrative and not restrictive limiting the scope of the present invention. In addition, the flowcharts shown in the figures are merely sequential order shown for illustrative purposes to achieve the most desirable result in embodying the present invention, and it is apparent that other additional steps may be provided, or some steps may be deleted.

Embodiments of the subject matter and the functional operations described in this specification can be implemented in digital electric circuitry, or in computer software, firmware, or hardware including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by or to control the operation of a data processing apparatus.

The tangible program carrier can be a computer readable medium, which can be a machine-readable storage device, a machine-readable storage substrate, a memory device, a composition of matter affecting a machine-readable propagated signal, or any combination thereof.

Meanwhile, the term ‘apparatus’ or ‘system’ encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or any combination thereof.

A computer program (also referred to as a program, software, software application, script, or code) can be written in any form of programming language, including compiled or interpreted languages, or declarative or procedural languages, and can be deployed in any form, including as a stand-alone program or as a module, component, subroutine, or other unit suitable for use in a computing environment.

A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code).

A computer program can be deployed to be executed on one computer or on multiple computers that are located at one site or distributed across multiple sites and are interconnected by a wired/wireless communication network.

Computer-readable media suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. Further, the processor and memory can be supplemented by, or incorporated in, special purpose logic circuitry.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network.

Hereinafter, further specific embodiments capable of implementing the system and the method described in this specification together with the contents described will be described in detail.

The method described in this specification may be partially or entirely used through a means executing computer software, program codes or instructions on a server related to a device or a web-based storage system or one or more processors included in the server. Herein, the processor may be part of a computing platform such as a server, a client, a network infrastructure, a mobile computing platform, a fixed computing platform or the like, and, specifically, the processor may be any type of computer or processing device capable of executing program instructions, codes and the like. In addition, the processor may further include memory for storing methods, instructions, codes and programs, and if the processor does not include the memory, the processor can access, through a separate interface, a storage device such as CD-ROM, DVD, memory, hard disk, flash drive, RAM, ROM, cache or the like which stores the methods, instructions, codes and programs.

In addition, the system and the method described in this specification may be partially or entirely used through an apparatus which executes computer software on a server, a client, a gateway, a hub, a router or network hardware. Herein, the software may be executed on various kinds of servers such as a file server, a print server, a domain server, an Internet server, an Intranet server, a host server, a distributed server and the like and the servers may include a memory, a processor, a computer readable storage medium, a storage medium, a communication device, a port, a client and an interface capable of accessing the other servers through a wired or wireless network.

In addition, the methods, instructions and codes according to the provided invention also can be executed by a server, and other devices needed to execute the method may be implemented as part of a hierarchical structure associated with a server.

In addition, the server may provide an interface to other devices including, but not limited to, clients, other servers, printers, database servers, print servers, file servers, communication servers, distributed servers and the like, and a connection through the interface may facilitate remote execution of a program through a wired or wireless network.

In addition, any one of the devices connected to the server through an interface may include at least one storage device capable of storing the methods, instructions, codes and the like, and a central processor of the server may provide instructions, codes or the like to be executed on different devices to the devices so as to be stored in the storage device.

On the other hand, the system and the method described in this specification may be partially or entirely used through a network infrastructure. Herein, the network infrastructure may include devices such as a computing device, a server, a router, a hub, a firewall, a client, a personal computer, a communication device, a routing device and the like and separate modules capable of executing a function of its own, and in addition to the devices and modules mentioned above, the network infrastructure may further include a storage medium such as a flash memory, a buffer, a stack, RAM, ROM or the like. In addition, the methods, instructions and codes may also be executed and stored by any one of the devices, modules and storage media included in the network infrastructure, and other devices needed to execute the method may also be implemented as part of the network infrastructure.

The system and the method described in this specification may be implemented in hardware or a combination of hardware and software appropriate to a specific application. Herein, the hardware may include general purpose computer devices such as a personal computer, a mobile communication terminal and the like and enterprise specific devices, and the computer device may be implemented as a device including a memory, a microprocessor, a microcontroller, a digital signal processor, an application specific integrated circuits, a programmable gate array, a programmable array logic or the like or a combination of these.

The computer software, instructions, codes and the like described above may be stored or accessed by a readable device, and, herein, the readable device may include memory such as a computer component provided with digital data used for computing for a predetermined time period, a semiconductor storage such as RAM or ROM, a permanent storage such as an optical disk, a mass storage such as a hard disk, a tape, a drum or the like, an optical storage such as a CD or a DVD, a flash memory, a floppy disk, a magnetic tape, a paper tape, a stand-alone RAM disk, a mass storage which can be mounted on a computer, a dynamic memory, a static memory, a variable storage, a network connection type storage such as a cloud and the like. Meanwhile, herein, although the instructions, codes and the like includes all of languages such as a data-oriented language such as SQL, dBase or the like, a system language such as C, Objective C, C++, assembly or the like, an architecture language such as Java, NET or the like, and an application language such as PHP, Ruby, Perl, Python or the like, it is not limited thereto and may include all the languages widely known to those skilled in the art.

In addition, the term ‘computer-readable medium’ described in this specification refers to any medium that participates in providing instructions to a processor to execute a program. Specifically, although the medium includes a non-volatile medium such as a data storage device, an optical disk, a magnetic disk or the like, a volatile medium such as a dynamic memory or the like, and a transmission medium for transmitting data, such as a coaxial cable, a copper wire, an optical fiber or the like, it is not limited thereto.

Meanwhile, all the elements executing technical features of the present invention included in the block diagrams and flowcharts shown in the accompanying drawings of the present invention mean logical boundaries between the elements.

However, according to an embodiment of software or hardware, elements and features shown in the figures are implemented in the form of an independent software module, a monolithic software structure, a code, a work or a combination of these, and since the functions of the elements and features can be implemented by storing them in a medium which can be executed in a computer provided with a processor capable of executing stored program codes, instructions and the like, all the embodiments can also be regarded as within the scope of the present invention.

Accordingly, although the accompanying drawings and descriptions thereof explain technical features of the present invention, the technical features should not be simply deduced while a specific array of software for implementing the technical features is not mentioned clearly. That is, various embodiments described above may exist, and since part of such embodiments can be modified while possessing technical features the same as those of the present invention, this can also be regarded as within the scope of the present invention.

In addition, while operations are depicted in a particular order in the flowcharts of the drawings, this should not be understood as requiring that such operations be performed in the particular order shown or in sequential order, or that all illustrated operations must be performed to achieve desirable results. In certain circumstances, multi-tasking and parallel processing can be advantageous. Moreover, the separation of various system components in the embodiments described above should not be understood as requiring such separation in all embodiments and it should be understood that the described program components and systems can generally be integrated together in a single software product or packaged into multiple software products.

As described above, this specification is not intended to limit the present invention to the presented specific terms. While the present invention has been described in detail with reference to the particular illustrative embodiments, those skilled in the art can alter, change or modify the embodiments without departing from the scope and spirit of the present invention.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An apparatus for managing a global construction business, the apparatus comprising
an electric manual unit deriving a task hierarchy in life stages to include a ‘plan and program stage’, a ‘design stage’, a ‘construction order and contract stage’, a ‘construction stage’, and an ‘operation and maintenance stage’ based on business process breakdown structure (BPS) information stored in a database according to delivery method selection information input by an ordering organization; providing to a responsible entity information required for performing a task; and providing to any one of the responsible entity, a revising entity, or an assigning entity performed task information performed by the responsible entity; and
a BPS mapping unit providing visualized information so that a temporal flow of the task hierarchy in life stages derived by the electric manual unit can be easily comprehended.

2. The apparatus of claim 1, wherein the electric manual unit includes:
a BPS deriving unit constituting the task hierarchy in life stages of a first level to a third level based on the BPS information stored in the database according to the delivery method selection information input by the ordering organization;
an input unit providing information required for performing a task that is required for performing a third level task, and receiving and storing the performed task information performed by the responsible entity;
an output unit providing the performed task information performed by the responsible entity to any one of the responsible entity, the revising entity, or the assigning entity; and
a legal history providing unit providing legal information related to performing a third level task.

3. The apparatus of claim 1, further comprising:
a delivery method selecting unit selecting any one of a ‘design-bid-build system’, a ‘design-build system’, an ‘alternate bid system’, a ‘schematic design technical proposal bid system’, or a ‘working design technical proposal bid system’ as a delivery method based on construction project post-evaluation information stored in the database according the delivery method selection information input by the ordering organization.

4. The apparatus of claim 3, wherein the delivery method selecting unit includes:
a parameter value deriving unit deriving parameter values of parameter factors of a corresponding business based on the delivery method selection information including order information and construction business information;
a weighted value calculating unit deriving degrees of influence of the respective parameter factors on selecting the delivery method as weighted values based on the construction project post-evaluation information stored in the database; and
a delivery method deriving unit deriving a delivery method of an established business having the highest similarity based on the parameter values of the parameter factors of the corresponding business and derived weighted values of the parameter factors.

5. The apparatus of claim 4, wherein the delivery method selecting unit includes: a performance factor deriving unit deriving a result value of a performance factor including at least one of a rate of change in a business expense relative to a planned expense, a rate of change in business period relative to a planned period, and a benefit cost (B/C) ratio of each established business based on the construction project post-evaluation information stored in the database.

6. The apparatus of claim 5, wherein the delivery method selecting unit includes: a performance calculating unit calculating a performance of the established business as an index based on the derived result value of the performance factor and influence values of the respective performance factors.

7. A method of managing a global construction business, the method being performed by an electric manual unit and comprising:
a BPS deriving step S100 of deriving a task hierarchy by a life cycle to include a ‘plan and program stage’, a ‘design stage’, a ‘construction order and contract stage’, a ‘construction stage’, and an ‘operation and maintenance stage’ based on BPS information stored in a database according to delivery method selection information input by an ordering organization;
a necessary information providing step S200 of providing to a responsible entity information required for performing a task; and
a performed task information providing step S300 of providing performed task information performed by the responsible entity to any one of the responsible entity, a revising entity, or an assigning entity.

8. The method of claim 7, further comprising: a visual information providing step S400 of proving visualized information so that a temporal flow of the task hierarchy in life stages derived by the electric manual unit can be easily comprehended, the method being performed by a BPS mapping unit.

9. The method of claim 7, wherein in the necessary information providing step S200, the electrical manual unit provides legal information related to performing a task.

10. The method of claim 7, further comprising: a delivery method selecting step S000 of selecting any one of a ‘design-bid-build system’, a ‘design-build system’, an ‘alternate bid system’, a ‘schematic design technical proposal bid system’, or a ‘working design technical proposal bid system’ as a delivery method based on construction project post-evaluation information stored in the database according to the delivery method selection information input by the ordering organization, the method being performed by the delivery method selecting unit and before the BPS deriving step S100.

11. The method of claim 10, wherein the delivery method selecting step S000 includes:
a parameter value deriving step S010 of deriving parameter values of parameter factors of a corresponding business based on the delivery method selection information including order information and construction business information;
a weighted value calculating step S020 of calculating degrees of influence of the respective parameter factors on selecting the delivery method as weighed values based on the construction project post-evaluation information stored in the database; and
a delivery method deriving step S030 of deriving a delivery method of an established business having the highest similarity based on the parameter values of the parameter factors of the corresponding business and derived weighted values of the parameter factors.

12. The method of claim 11, wherein the delivery method selecting step S000 includes: a performance factor deriving step S040 of deriving a result value of a performance factor including at least one of a rate of change in business expenses relative to planned expenses, a rate of change in business period relative to a planned period, and a B/C ratio of each established business based on the construction project post-evaluation information stored in the database.

13. The method of claim 12, wherein the delivery method selecting step S000 includes: a performance calculating step S050 of calculating a performance of the established business as an index based on the derived result value of the performance factor and influence values of the respective performance factors.

14. A system for managing a global construction project, wherein the system includes: a database storing business management information for a construction business; a global construction business management apparatus receiving/transmitting the business management information from/to the database; and a terminal for inputting the business management information to the global construction business managing apparatus and for receiving performed business management information,
the global construction business managing apparatus includes:
an electric manual unit: deriving a task hierarchy in life stages to include a ‘plan and program stage’, a ‘design stage’, a ‘construction order and contract stage’, a ‘construction stage’, and an ‘operation and maintenance stage’ based on a business process breakdown structure (BPS) information stored in a database according to delivery method selection information input by an ordering organization providing to a responsible entity information required for performing a task, and providing performed task information performed by the responsible entity to any one of the responsible entity, a revising entity, or an assigning entity; and
a BPS mapping unit providing visualized information so that a temporal flow of the task hierarchy in life stages derived by the electric manual unit can be easily comprehended.
